(19) United States
(12) Patent Application Publication
(10) Pub. No.: US 2024/0257200 A1
(43) Pub. Date: Aug. 1, 2024

(54) CONTEXT SPECIFIC RECOMMENDATION GENERATOR BASED ON USER DATA

(71) Applicant: International Business Machines Corporation, Armonk, NY (US)

(72) Inventor: Swayam Prakash Ganguly, Kolkata (IN)

(21) Appl. No.: 18/162,974

(22) Filed: Feb. 1, 2023

(51) Int. Cl. G06Q 30/0601; G06F 40/166; G06F 40/253; G06F 40/295; G06F 40/30

(52) U.S. Cl. CPC G06Q 30/0621; G06F 40/166; G06F 40/253; G06F 40/295; G06F 40/30; G06Q 30/0631

(57) ABSTRACT

A computer-implemented method includes: with a sentiment analyzer, assigning a sentiment value to each of a number of statements indicating user sentiment about a product or service of a producer; with a context-specific customization tool, determining a context in which the producer provides the product or service, the context-specific customization tool to adjust the assigned sentiment value for each statement indicating user sentiment based on the determined context; and with an accumulator, accumulating the adjusted sentiment values from the number of statements to produce an overall user sentiment determination that interprets an import of the number of statements corrected for the determined context.

### BACKGROUND

Any economy is composed of participating entities that produce services or products that are used and consumed by other participants. In a sophisticated economy, there may be a vast array of different services and products that are being produced and utilized, both internally within an organization and externally among different enterprises. Each service or product will be provided within a specific context that is defined by the producers and users. This context may include a specific industry, one or more channels of distribution, a flow of information amongst producers and users, and a specific terminology regarding the service or product.

In any such context, there will likely be multiple producers that provide competing services or products. These producers will need to assess their performance in satisfying their users. The producer that can better satisfy users will be preferred and, thus, more successful.

### SUMMARY

According to an example of the present subject matter, a computer-implemented method is described. The computer-implemented method includes: with a context-specific customization tool, receiving user data from use of a product or service of a producer by a population of user and determining a context in which the producer provides the product or service; with the context-specific customization tool, assigning or adjusting a user satisfaction value for elements of the user data based on the determined context; and, with an accumulator, accumulating the values to produce an overall user satisfaction determination that interprets an import of the user data specific to the determined context.

According to another example of the present subject matter, a server for a network is described. The server includes an application to provide a context-specific analysis of a number of statements indicating user sentiment about a product or service of a producer. More specifically, the server includes: a processor; a memory; a network interface; and the application, the application including: a sentiment analyzer to assign a sentiment value to each of a number of statements indicating user sentiment about a product or service of a producer; a context-specific customization tool to determine a context in which the producer provides the product or service, the context-specific customization tool to adjust the assigned sentiment value for each statement indicating user sentiment based on the determined context; and an accumulator to accumulate the adjusted sentiment values from the number of statements to produce an overall user sentiment determination that interprets an import of the number of statements corrected for the determined context.

According to another example of the present subject matter, a computer program product is described. The computer program product comprises a computer readable storage medium having program instructions embodied therewith, the program instructions executable by a processor, to cause the processor to implement: a pre-processor implementing a Natural Language Processing (NLP) tool to disambiguate a number of statements by replacing ambiguous terms with specific terms, the number of statements indicating user sentiment about a product or service of a producer; a document dissector to separate statements input together into individual statements; a sentiment analyzer to assign a sentiment value to each of the number of statements; a context-specific customization tool to determine a context in which the producer provides the product or service, the context-specific customization tool to adjust the assigned sentiment value for each statement indicating user sentiment based on the determined context; an accumulator to accumulate the adjusted sentiment values from the number of statements to produce an overall user sentiment determination that interprets an import of the number of statements corrected for the determined context; and a recommendation generator to apply any of a series of rules to the overall user sentiment determination to generate a recommendation for responding to the overall user sentiment determination.

### BRIEF DESCRIPTION OF THE DRAWINGS

FIG. 1 depicts a computing environment for the execution of a computer-implemented method or application, according to an example of the principles described herein.

FIG. 2 depicts a computer network being used to implement an example of a computer-implemented method and application according to an example of the principles described herein.

FIG. 3 depicts a computer-implemented application for generating context specific recommendations for a producer, according to an example of the principles described herein.

FIG. 4 depicts a computer-implemented application for generating context specific recommendations for a producer using an array of user data sources, according to an example of the principles described herein.

FIG. 5 depicts a computer-implemented application for generating context specific recommendations for a producer including training and retraining of an artificial intelligence, according to an example of the principles described herein.

FIG. 6 depicts a flow-chart for the computer-implemented application for generating context specific recommendations for a producer, according to an example of the principles described herein.

FIG. 7 depicts a flow-chart for the computer-implemented application for generating context specific recommendations for a producer, according to an example of the principles described herein.

FIG. 8 depicts a computer program product for installing the application for generating context specific recommendations for a producer, according to an example of the principles described herein.

### DETAILED DESCRIPTION

As noted above, any economy is composed of participating entities that produce services or products that are used and consumed internally or externally by other participants. Each service or product that is produced, distributed and used will have its own context. As used herein and in the appended claims, the term “context” will refer to the circumstances surrounding the provision of a particular service or product. This context may include such details as industry of the service or product, a specific department within that industry, the means and location for production of the service or product, the entities involved in producing and using the product or services, one or more channels of distribution, a flow of information amongst producers and users, and, significantly, a specific terminology regarding the service or product.

Considering context is highly relevant because a similar term or indicator may have very different connotations in different contexts. For example, in a context where a producer is filling orders for users, the term “cancelled” may have a negative connotation by indicating that a user decided to cancel an order for the services or products or that the producer was unable to complete an order and had to cancel that order. Either situation indicates a negative outcome for the producer. However, in the context of a law firm providing legal services, having an order against a client “cancelled” may indicate a positive and desired outcome.

In another example, a user comment that an electronic device, such as a mobile phone, “gets hot very quickly,” has a negative connotation. In this context, the comment indicates that the device is a challenge to use and may not be functioning properly because of the heat generated by operation. Alternatively, the same comment with regard to a space heater is a positive comment. In this alternative context, the comment indicates that a user does not have to wait long for the heater to perform its intended function and provide heat.

In another example, considering numeric data, an increase in sales over time has a positive connotation indicating good or increasing user satisfaction. However, an increase in products returned or reported defective has a negative connotation indicating user dissatisfaction. In both cases, a numeric indicator is increasing. However, the context is determinative of whether that indicates user satisfaction or dissatisfaction. In another example, an increase in “points” has a positive connotation in terms of a student's score and a negative connotation in terms of a driver's license where points count toward possible suspension of the license. There are many other possible examples in which the context is determinative of whether a comment or other insight is positive or negative. Thus, considering the context in which comments are made or data is generated provides an accurate interpretation of that comment or data.

As noted above, producers need to assess their performance in satisfying their users. The producer that can better satisfy users will be more successful. However, accurately and timely assessing how services and products are being received by users can be a challenge for producers. Specifically, the opportunities for measuring performance and user satisfaction may present a variety of technical problems that need corresponding technical solutions, as described herein.

For example, data that could be used to measure performance and user satisfaction may be distributed across a number of different data repositories and formats. Specifically, user comments or sentiment regarding a producer's products or services may be posted to a number of social media sites or online discussion forums. User comments or input regarding a producer's products or services may be recorded in direct feedback mechanisms such as online surveys or polling. User comments or input regarding a producer's products or services may be recorded in the records of a user support service such as a live chat channel, a help line or call center.

Additionally, other records of the producer may provide data that can be used to ascertain or approximate a measure of user satisfaction. Specifically, sales data indicating sales of the producer's services and products and whether those sales are trending up or down can be used to ascertain market performance and user satisfaction. User returns of products or user cancellation of services can also be used to ascertain user satisfaction.

This vast array of disparate data regarding user satisfaction presents a technical problem for producers. Such data, because of its volume, diverse sourcing and separate formatting cannot be processed, reformatted, compiled and understood in any reasonable amount of time by human operators. Thus, a technical solution is needed to this technical data management problem.

Additionally, as noted above, any technical solution to managing and utilizing all of this user data should take into account the context in which the producer operates. Otherwise, any technical solution to managing and utilizing this user data may not produce results that are useful to the producer in guiding future operation. The following specification describes a technical solution to these technical problems, including accounting for context when enabling a producer to process and draw conclusions from the available user data.

As used herein and in the appended claims, the term “producer” refers broadly to any entity involved in providing a product or service to users. Thus, a producer may be, for example, any of a manufacturer, a vendor or a service provider.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse or any given order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used in the present specification and in the appended claims, the term “a number of” or similar language is meant to be understood broadly as any positive number including 1 to infinity.

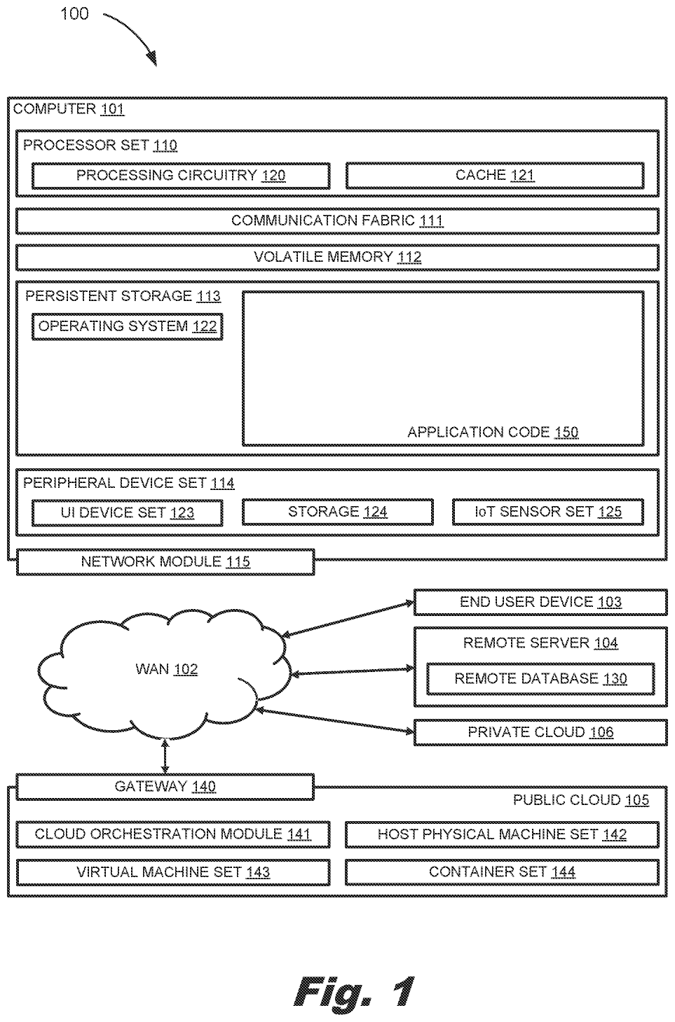

Turning now to the figures, FIG. 1 depicts a computing environment 100 for the execution of unknown object sub-class identification, according to an example of the principles described herein.

Computing environment 100 contains an example of an environment for the execution of at least some of the computer code involved in performing the inventive methods, an application to provide context specific recommendations to producers regarding the satisfaction of their users. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

The EUD 103 may be a client device operated by a producer of services or products that wants an analysis of available user data to ascertain user satisfaction. Operation of the EUD 103 for this objective will be described in further detail below.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

As described further below, the EUD 103 may use the network 102 to access an application on remote server 104. The application will access, again using the network 102, available user data. The application will then analyze the user data, with context specific analysis, to ascertain user satisfaction and generate recommendations for the producer based on the analysis.

PUBLIC CLOUD 105 is any computer system available for use by multiple entities that provides on-demand availability of computer system resources and/or other computer capabilities, especially data storage (cloud storage) and computing power, without direct active management by the user Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

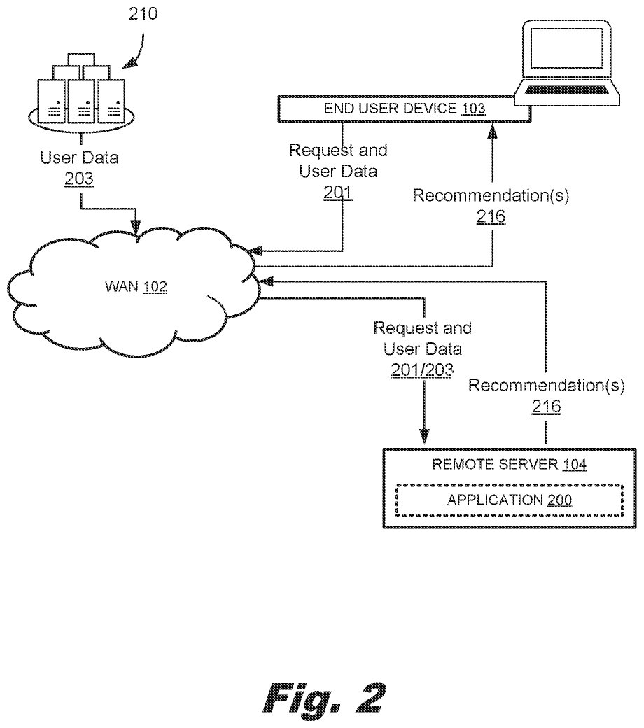

FIG. 2 depicts a computer network being used as an example of a computer-implemented method and application according to the principles described herein. The devices shown in FIG. 2 were also illustrated in FIG. 1 and are further described above.

As noted above, the EUD 103 may be a networked device operated by a producer of services or products. In this example, the producer wants an analysis of available user data to ascertain user satisfaction. Operation of the EUD 103 for this objective will be described in further detail below.

As shown in FIG. 2, acting as a client, the EUD 103 will send a request for analysis to the application 200 on the remote server 104. This request may include user data 201 already collected by the producer and available to the EUD 103. In various examples, this user data may include sales records by volume and over time. It may also include user feedback collected by the producer or records from a user support or help service provided by the producer for users. In some examples, a human user may send a specific request to the application 200 for analysis of indicated user data. In other examples, simply providing a feed of data, which may be entirely automated, to the application 200 will initiate analysis as described herein. As used herein, the term “request” covers either scenario, with or without a human operator involved, by which data for analysis is input to the application 200.

In addition to any user data provided by the EUD 103, the application 200 may also use the network 102 to collect user data 203 from other sources. For example, social media or public discussion forums hosted on the network 102 may contain comments or sentiments expressed by users about the products or services of the producer.

The application 200 will analyze all of the user data 201/203 available. As described in further detail below, this analysis will also account for the specific context in which the producer operates to provide the products or services being used. Accordingly, the available user data 201/203 will be correctly interpreted given the idiosyncrasies or terminology used in that context.

After analyzing the available user data 201/203, the application 200 will provide the context-specific analysis to the EUD 103. This report may include recommendations 216 derived from the analysis of the user data. The application 200 will return the data analysis and recommendations 216 via the network 102 to the requesting client EUD 103. As described in further detail below, the recommendations will be specific to the context in which the producer operates.

The EUD 103 may include a client application that communicates over the network 102 with an Application Programming Interface (API) of the main application 200. Using the API, the request and user data 201 are submitted to the application 200. Alternatively, the application 200 may be web based, and the EUD 103 may execute a browser through which a user can remotely access the application 200 to submit the request and user data 201.

In some examples, the EUD may only submit a request without any accompanying user data. In such a case, the application 200 may utilize only user data relative to the producer's products or services that is available from other sources 210.

With or without accompanying user data, the request 201 may include instructions that define which other sources 210 are to be accessed and scraped for user data related to the producer's products or services. These instructions may be input by an operator of the EUD 103 each time a request is submitted, may be set once by the operator and copied with each new request or may be entirely automated by the programming of either the EUD 103 or the application 200. These instructions may specify network addresses, APIs, login credentials or other details to provide the application 200 with access to the other source 210 that may include relevant user data for analysis.

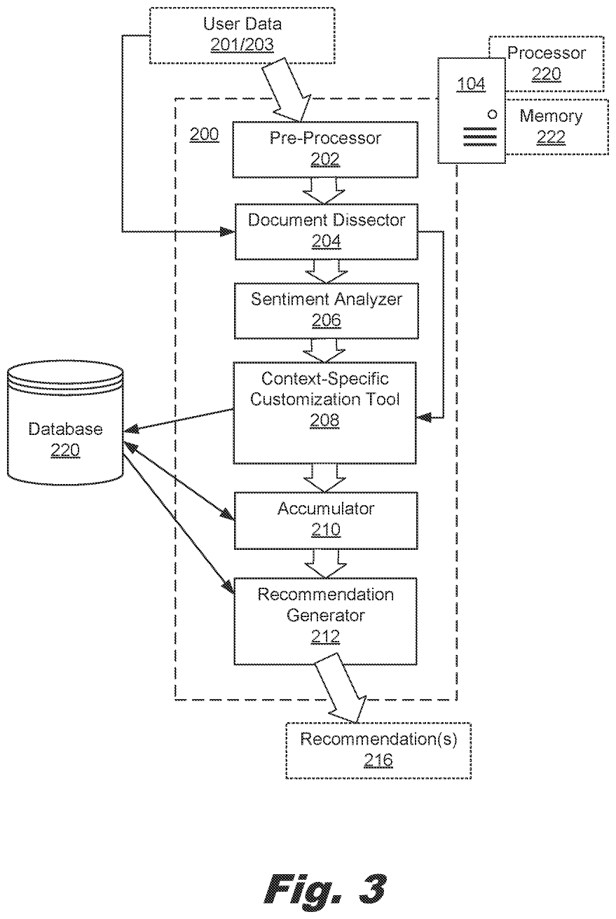

FIG. 3 depicts a computer-implemented application 200 for generating context specific recommendations for a producer according to an example of the principles described herein. As described above and also illustrated in FIG. 3, the application 200 may be hosted on a remote server 104 that is accessible via the network 102. The remote server 104 will include a processor 220 (or an array of processing cores) and a memory 222 (or an array of memory devices). In other examples, the application 200 can be embodied in an application specific integrated circuit (ASIC), a field programmable gate array (FPGA) and other hardware implementations. The application 200 may also be embodied as a combination of hardware, firmware and/or software components. As will be described below, the application 200 includes artificial intelligence so as to provide context-specific analysis and recommendations based on the user data 201/203.

The user data 201/203 may be generally of two different types. A first type of user data is composed of statements, usually in natural language, that have actually been made by users of the producer's products or services. As noted elsewhere, these statements may be in the form of direct user feedback to the producer or an agent of the producer; may be gleaned from social media, including online discussion forums; or may come from the records of a user help service such as a live chat, call center or help line. A second type of user data may be any other data that indicates user sentiment regarding the producer's goods or services. Examples of this second type of user data may include an increase in sales over time or producer performance data, such as how many scheduled deliveries were timely or successfully made or how many units of a product were returned or reported as failed or defective.

As shown in FIG. 3, the components of the application 200 are as follows. If the user data is of the first type, e.g., natural language user statements, The user data 201/203 is first conditioned via a pre-processor 202. The function of the pre-processor 202 is to condition the user data 201/203 by replacing pronouns and similar parts of speech to facilitate subsequent processing of the data. The pre-processor 202 may include a Natural Language Processing (NLP) tool.

Natural language processing (NLP) is an interdisciplinary field including linguistics, computer science, and artificial intelligence concerned with the interactions between computers and human language. In particular, NLP provides programming for computers to process and analyze large amounts of natural language data. The result is a computer capable of “understanding” the contents of documents, including the contextual nuances of the language within those documents. Any of the various NLP systems can be used in the application 200. The application 200 may include NLP programming or may call a separate NLP system.

The pre-processor will specifically employ NLP as follows. The user data 201/203 may contain any volume of comments, in natural language, that users have made about the producer's services or products. Frequently, in such natural language, a user may make a first statement about a product, referring specifically to the product, and may then make additional statements referring to the product using a pronoun or other identifier, such as “it,” “this product.” “that product,” and the like.

The pre-processor 202 will use Natural Language Processing to disambiguate such statements by replacing the pronoun or other identifiers with the earlier word(s) they replace or some other clear indicator of the specific product or service being discussed. This allows the different statements in the user data to be separated for subsequent analysis without introducing confusion as to what product or service is the object of each statement.

After passing through the pre-processor 202, the conditioned user data is provided to a document dissector 204. The document dissector 204 will separate the individual statements made in the user data for subsequent analysis. The document dissector 204 may operate using punctuation cues or NLP to identify each individual statement about a producer's product or service.

The individual statements of the user data 201/203 are then processed by a sentiment analyzer 206. The sentiment analyzer is another instance of an NLP tool. Specifically, the sentiment analyzer 206 is a lexicon and rule-based sentiment analysis tool that ascertains the sentiment, positive, negative or neutral, expressed in each statement in the user data 201/203. In one example, a known sentiment analyzer that can be used is the Valence Aware Dictionary and sEntiment Reasoner (VADER). VADER is an available open-source sentiment analyzer that is specifically attuned to sentiments expressed in social media, and works well on texts from other domains.

Next, the user data 201/203 is provided to the context-specific customization tool 208. The sentiment analyzer 206 provides a sentiment specific rating or value to each statement or sentence. However, as noted above, the sentiment analyzer 206 may be unaware of the context-specific usage of the terms in user statements. This may be described as industry specific idiosyncrasies. For example, as explained above, the word “cancelled” may have a negative connotation in many contexts, but may have a positive connotation in one or more specific contexts. Consequently, the sentiment analyzer 206 may tag a statement including the word “cancelled” as expressing a negative sentiment when, in the given context, the statement should be tagged as expressing a positive sentiment.

If the user data 201/203 is of the second type, e.g., numeric trend or performance data rather than natural language statements, the user data can bypass the pre-processor 202 and the sentiment analyzer 206. The document dissector 204 may still divide the user data into individual records instances which are then provided to the context-specific customization tool 208. This is illustrated by the alternative arrows in FIG. 3. Thus, the sentiment analyzer is used when the user data source is from some human interaction but will be bypassed when the user data is of the second type. In such cases, the context-specific customization tool 208 is programmed to analyze the second type user data to determine the context.

In either case, the context-specific customization tool 208 will analyze the user data 201/203 to determine the context. In a basic example, this may be analyzing the user data 201/203 to identify the industry in which the producer and users operate. However, other specific contextual details besides only the industry in question may be ascertained to determine a more specific context for the user data. Based on the determined context, the context-specific customization tool 208 may then alter or reverse the sentiment value provided by the sentiment analyzer 206 or may assign a similar value to the user data for non-textual data that was not processed by the sentiment analyzer.

Artificial intelligence is used to assign a context to the user data 201/203. This will be described in more detail below. Once the context is determined, the context-specific customization tool 208 may access a database 220 with rules the determined context that specify how value should be assigned to the user data including whether a sentiment value usually assigned should be altered or even reversed because of the determined context. To extend the example discussed above, if the determined context is a segment of the legal industry in which the term “cancelled” carries a positive connotation, the database 220 will contain a rule for that context that any user statements tagged as negative based on usage of the term “cancelled” will be recharacterized as having a positive sentiment value.

The determined context may be more specific that simply the industry in question. For example, the context-specific customization tool 208 may determine a context specific to a type of department or operation within a given industry, such as Human Resources, Operations, Procurement, Quality Control, and others. Even among different departments or operations common or related terms may have different meanings or connotations that should be considered when interpretating user statements.

Next, the accumulator 210 will receive the user data after values have been assigned or updated to account for context by the context-specific customization tool 208. The accumulator 210 will then count or quantify the values in order to determine whether the overall user sentiment is positive, neutral or negative. The accumulator 210 may also, in some examples, weight different user data or statements differently when quantifying the overall value.

The accumulator 210 may also separate statements by different department, group, operation or other contextual division so as to provide an overall sentiment understanding for each such specific context, perhaps within a single producer organization. The accumulator 210 will also have access to the database 220 to access rules for weighting the value of various user data or statements and to record the results of aggregating the values into an overall user satisfaction value.

Lastly, the recommendation generator 212 will receive the output of the accumulator 210 and use that output to generate specific recommendations for the requesting producer. For example, the recommendation generator 212 may also access the database 220 for rules that dictate a specific recommendation in response to a determined overall user satisfaction value. For example, industry experts or expertise may be used to write a rule such as: if the determined overall user satisfaction value for context A specific to a particular operation within the producer is in a range of B-C, the producer should take action D. Any number of such recommendation rules for each of the possible particular operations within a variety of contexts can be determined

and stored in the database 220. The recommendation generator 212 then provides the determined recommendation(s) 216 to the producer as described above in connection with FIG. 2.

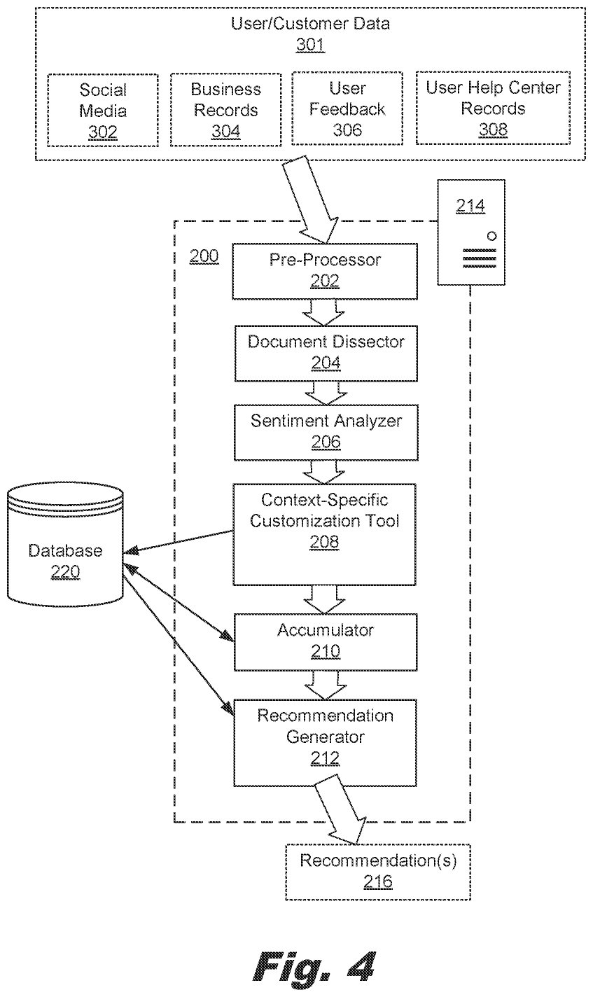

FIG. 4 depicts a computer-implemented application for generating context specific recommendations for a producer using an array of user data sources, according to an example of the principles described herein. As shown in FIG. 4, the user data, in this example, user or customer data 301, can be obtained by the application 200 from a variety of disparate sources.

For example, the data 301 can be taken from social media 302, the operational or business records 304 of the requesting producer, direct user feedback 306 collected by the producer or other agent and the records of a user help center 308 operated by the producer or other entity. The user help center may include a call center, help line or live chat function through which users can seek assistance with using the products or services of a producer.

Social media data, user feedback and user help center records may include user statements about the producer's products or services in different formats. For example, the social media data set 302 may include posts written in natural language. The help center records 308 may include conversations or dialogue that includes user statements about the products or services. The pre-processor 202 and document dissector 204, as described herein, remove these formatting barriers by reducing the user data to individual user statements that can be operated on by the sentiment analyzer 206.

The business records 304 may be numeric data that indicates, for example, a trend in user purchases over time, a rate of successful deliveries or a number of returned or reported products that have failed. The pre-processor 202 may be programmed to recognize such data and produce therefrom a statement that can be processed by the sentiment analyzer. For example, the pre-processor 202 may receive numeric business records showing a 2% increase in sales since the past measurement period. The pre-processor 202 then outputs a text statement such as “Sales of service X have increased by 2% in the current quarter.” This statement can then be passed through the document dissector 204 and input to the sentiment analyzer 206. The sentiment analyzer, being unaware of whether a 2% change is good or bad, will just pass this data point to the context specific customization tool. The context specific customization tool will assign a context specific sentiment value based on values stored in Database 220.

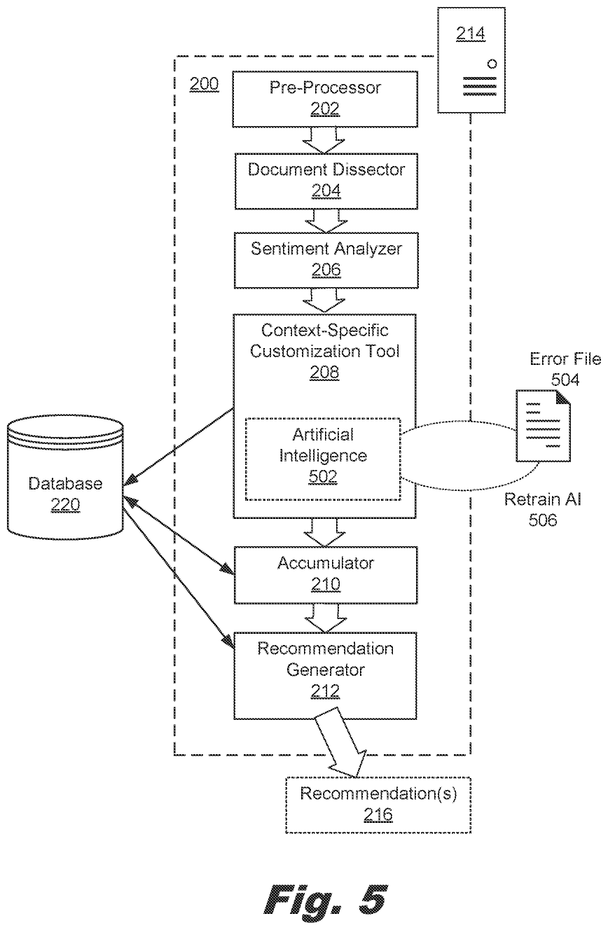

FIG. 5 depicts a computer-implemented application for generating context specific recommendations for a producer with details about the context specific customization tool including training and retraining of an artificial intelligence, according to an example of the principles described herein. As shown in FIG. 5, the context-specific customization tool includes an artificial intelligence 502. This artificial intelligence is trained to determine a context, as defined herein, based on the user data being processed.

For example, the artificial intelligence 502 is trained using a training set of user statements that are associated with a specific context. The statements include terminology or phrasing that indicates a specific context. For example, a part of the training set may be a user statement: “The printing for the product was very precise.” This statement could be associated with a document printing context or a 3D printing context. A related statement could be: “The tensile strength of the product met specifications.” This statement would further indicate a 3D printing, rather than a document printing context. In the training set, these two statements would be associated with a 3D printing context determination. Given a large volume of such user statements associated with a particular context, the artificial intelligence 502 is trained to receive a set of user statements and determine a corresponding context.

Machine learning techniques may be used in the artificial intelligence 502. Any of a number of machine learning algorithms may be used including, but not limited to, Linear regression, Logistic regression, Decision tree, the SVM algorithm, the Naive Bayes algorithm, the Random forest algorithm, Dimensionality reduction algorithms, the Gradient boosting algorithm, the AdaBoosting algorithm, the KNN algorithm, K means in which (k is a positive integer, that is typically small), for example, if k=1, then the object is simply assigned to the class of the single nearest neighbor.

As shown in FIG. 5, during operation, if the artificial intelligence 502 is observed to make an error in identifying the context of a batch of user statements, the error can be recorded in an error file 504. The correct context that should have been identified is also entered into the error file 504 in association with the mis-identified batch of user statements. This error file 504 then is then used as an additional training set 506 to refine the training of the artificial intelligence 502. Over time, this will allow the artificial intelligence 502 to become more robust with fewer errors in identifying the context of a set of user statements.

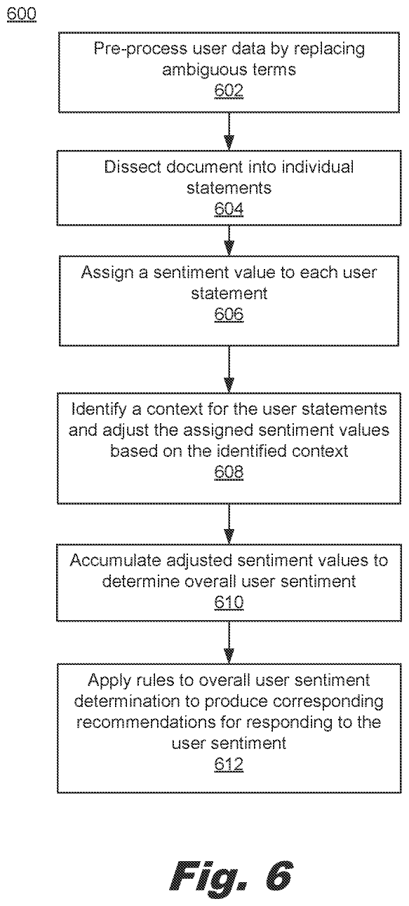

FIG. 6 depicts a flow-chart 600 for the computer-implemented application for generating context specific recommendations for a producer, according to an example of the principles described herein. The different steps in the flow-chart may correspond to the different components illustrated in the application 200 in FIG. 3, for example.

As shown in FIG. 6, the user data comprising user commentary is pre-processed 602, as described herein, to remove potentially ambiguous terms, such as “it.” Any such potentially ambiguous terms are replaced with specific terms.

Next, the user commentary is dissected 604 into individual statements. Then, a sentiment value is assigned 606 to each user statement.

A context is then identified 608 for the batch of user statements. This may be done using a trained artificial intelligence. The sentiment value assigned to each user statement is then possibly adjusted based on the identified context, as described herein.

Lastly, the adjusted sentiment values are accumulated 610 to determined overall user sentiment. Based on this overall user sentiment, rules are applied 612 that dictate corresponding recommendations to the producer for responding to the user sentiment.

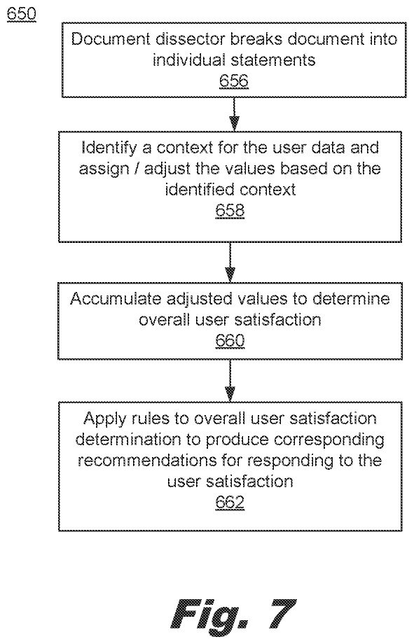

FIG. 7 depicts a flow-chart 650 for the computer-implemented application for generating context specific recommendations for a producer, according to an example of the principles described herein. This flow-chart is specific to the example in which user data of the second-type is being analyzed.

As shown in FIG. 7, a document dissector may begin by breaking 656 a document into individual statements, if needed. Then, a context is identified 658 for the user data. This may be done using a trained artificial intelligence. A value is assigned to the elements of the user data or adjusted based on the context, as described herein. For example, if the user data is identified as sales data, the context will dictate that an increase with time indicates a positive user satisfaction value. If the user data is identified as product returns or failures, the context will dictate that an increase with time indicates a negative user satisfaction value.

Lastly, the context specific values are accumulated 660 to determined overall user satisfaction. Based on this overall user satisfaction, rules are applied 662 that indicate corresponding recommendations to the producer for responding to the user sentiment.

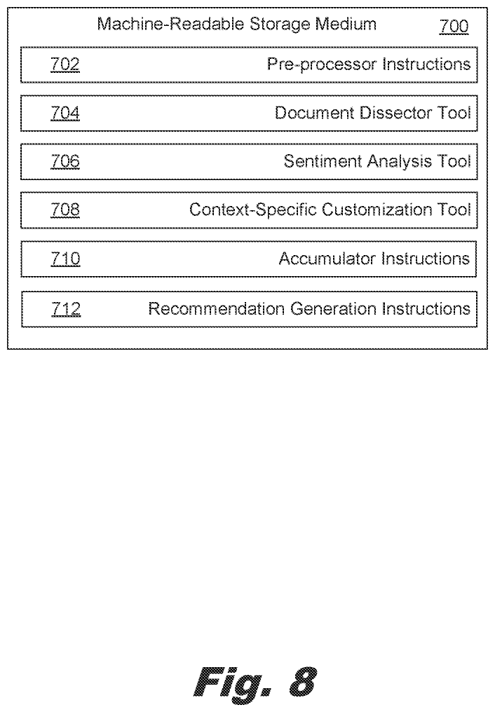

FIG. 8 depicts a computer program product for installing the application for generating context specific recommendations for a producer, according to an example of the principles described herein. As shown in FIG. 8, a non-transitory, computer-readable storage medium 700 may contain all the components of the application 200. Specifically, the medium 700 may store pre-processor instructions 702, a document dissector tool 704, a sentiment analysis tool 706, a context-specific customization tool 708, accumulator instructors 710 and recommendation generation instructions 712.

In summary, a technical problem exists in making use of the large volume of data that documents or indicates user sentiment and satisfaction with a product or service. This data is stored in a variety of different locations, systems and formats. However, the producer of the product or service may need to determine actionable goals to improve user or customer satisfaction. The producer may ask: What are our areas of improvement? What can we do to delight our customers? What are the parameters where we are doing alright? What are the ways that we are delighting our customers? Again, there are immense amounts of data available in which the answer to these questions is hidden. This data may be available freely over the internet and in data present in various data stored by the producer. However, the vast volume of the data prevents human-based analysis in any reasonable amount of time and cost.

The technical solution described herein is to build smart AI application that can be fed and trained with data from various sources. The application will process this input data and will generate analysis and recommendations based on the data fed into the system. As described herein, the main components of the system are:

Pre-Processor—: This is the component that will intercept all the feeds coming into the system. The purpose of this component is to replace words like “It”, “this” with actual words which would complete the sense of the sentence to be consumed by the “Document Shredder” component.

Document Dissector/Shredder—: This is a program that will read a document and break it into single line and feed the lines to the Sentiment Analyzer.

Sentiment Analyzer—: This is a lexicon and rule-based sentiment analysis tool based, for example, on VADER, that is specifically attuned to sentiments expressed in social media. Examples of Sample run from Sentiment Analyzer, with input sentences and polarity, where a higher positive value denotes a favorable customer feedback and a negative value denotes negative feedback.

I didn't get my cake moreover the food was also not good
Compound Polarity: −0.3412
I didn't get my cake but the food was good
Compound Polarity: 0.5927
I didn't get my pie but the food was passible.
Compound Polarity: 0.0
The service was kind of good.
Compound Polarity: 0.4404
The food was good, but the environment was uncompelling and the
location is not great.
Compound Polarity: −0.7042
The food was really bad, horrible experience.
Compound Polarity: −0.8211
At least it isn't a horrible place.
Compound Polarity: 0.431
:) and :D
Compound Polarity: 0.7925
“”
Compound Polarity: 0.0
The catering service is very bad!
Compound Polarity: −0.5461
This doesn't work! But I'll get by, lol
Compound Polarity: 0.2228

Industry Specific Customization—: As noted above, for the first type of user data, the Sentiment Analyzer provides a sentiment specific rating to each sentence, but it is unaware about the industry specific idiosyncrasies. The word Cancelled may have a negative sentiment in most industries but for a Law Firm getting a bail cancelled may be a successful outcome and a positive sentiment associated to it. Similarly, a sentence “It gets hot very quickly” when applied to a mobile phone will have a negative sentiment but the same sentence in case of a heater will have positive sentiment associated. The purpose of this to either preserve the same sentiment as used in common cases or change the sentiment based on the artificial intelligence. It will also, provide the industry specific categorization of the department of the industry like HR, Operations, Procurement, Quality etc. This will also provide the area of operation that is referred in the statement example “I did not get bacon” or “The food was too spicy” both points to dissatisfaction with the catering service. The categorization may fail in certain cases to identify the Department, Service or Sub system, this will generate an error file, which can be used to re-train the system to make it more robust over time.

If the Sentiment Analyzer is not used because the user data is of the second type, the context specific customization tool will assign values for analysis of the user data. In an example, the producer may be a pharmacy delivering prescriptions and the user data being used includes the records of whether medicine was correctly delivered, not delivered or only partially delivered. In such an example, the name of the user data set or the report is “Pharmacy Delivery Report.” This will allow the context specific customization tool to identify the industry as “Health Care” and a department as “Pharmacy.” A data dictionary can be used to ensure that equivalent terms such as Doctor, PCP (Primary Care Physician), Physician, Medical Practitioner and similar terms are interpreted in the same way in the context/industry specific customization. Other key words in the user data or report, such as doctor, medicine, diagnosis will allow the trained AI of the context specific customization tool to identify the context of the user data. In this example, the context specific customization tool would receive the data and might generate output as follows:

```
  Delivered
  Compound Polarity: .9999 Hash:
  “ba7816bf8f01cfea414140de5dae2223b00361a396177a9cb410ff61f20015ad”
  Not Delivered
  Compound Polarity: −0.9999 Hash:
  “ba7816bf8f01cfea414140de5dae2223b00361a396177a9cb410ff61f20015ad”
  Partially Delivered: (10 requested 6 delivered)
  Compound Polarity: −0.4000 0.4 Hash:
  “ba7816bf8f01cfea414140de5dae2223b00361a396177a9cb410ff61f20015ad”
Consequently, the context specific customization tool might then provide the following feed to
accumulator
  {Industry: Healthcare, Department: ”Pharmacy”, Service: ”In patient medicine request”,
  score:”−.4000”,cost: − 40 hash:
  fd0568e53f09cd0b8050b492b142f35a94db7f4e241a217accc1b2b2a4fdb63b}
  Here the industry customization provided the assumption a non-delivery of a medicine
  has a cost impact of −1 unit.
```

Accumulator—: This will accumulate all the sentiment ratings into various groups or departments and the services provided by the “Customization” component. The scores of all the departments and services are summed up to judge, if the total score is positive or negative. A total score of ˜0.01 can be treated as neutral. The number of hits associated to a service is also calculated by the accumulator. The output of accumulator may be, for example:

{Industry: Airlines, Department: ”Flight Operation”, Service: ”Inflight Entertainment”,
Sub-system: ”All”, score:”−.890”, count:10K, cost:10M, hash:
fd0568e53f09cd0b8050b492b142f35a94db7f4e241a217accc1b2b2a4fdb63b}
{Industry: Airlines, Department: ”Flight Operation”, Service: ”Inflight Entertainment”,
Sub-system: ”Media”, score:”−.990”, count:8K, cost:7M, hash:
9f56e761d79bfdb34304a012586cb04d16b435ef6130091a97702e559260a2f2}
{Industry: Airlines, Department: ”Flight Operation”, Service: ”Inflight Entertainment”,
Sub-system: ”Audio” score:”−.590,” count:2K, cost:1M, hash:
77630fe658bcb74035f4ed731c2e9be33acf61f9e7dd8e1964e8c509e5169c0e}
{Industry: Airlines, Department: ”Flight Operation”, Service: ”Inflight Catering”, Sub-
system: ”All” score:”−.890” ,count:20K, cost:18M,hash:
5fc328f5a2c69c067474254a2da10bc13ce27d124c26c3a3a434c28bf6cec68c}

The result from Sub-System All will be the accumulated result for the Department and Service combination. The score for the sub system All will be multiplied by the count will be the final score for the Department and Service communication that will be used for the final ranking. “Inflight Entertainment” and “Flight Operation” both has a score of −0.89, but result of “Inflight Catering” is based on 20K records, whereas score for “Inflight Entertainment” is based on 10K records, larger number of records will tend to average out the outcomes so “Inflight Catering” needs greater attention, hence will be ranked higher.

Recommendation Generator—: This will be an industry specific recommendation generator that will take the result of the Accumulator and serve recommendation based on pre feed possible solutions by Industry SMEs to improve the Service affected.

### Example

Inflight catering service recommendation could be to provide:
1) Pre booked meals
2) Wider choice of meals
3) Choice of vendors supplying meals.

In another example, the user data may indicate product or component failure. One such example maybe a screw that has been shown to fail on a significant basis. The recommendation generator may use the input data to identify a screw with correct gauze, length and/or alignment. The system for which the analysis is being done can then act on this recommendation to produce or procure parts which are less likely to be faulty due to this identified point of failure, which is the screw in this case. In this case inputs to preprocessor components can be a product review of rejected components

In another example related to a pharmacy delivery report, the application 200 may operate as follows. In this example, the user data is an Internal Pharmacy Delivery Report as follows.

Internal Pharmacy Delivery Report

| | | | | Quantity | Quantity | |
|---|---|---|---|---|---|---|
| Date | Doctor | Diagnosis | Medicine | Requested | Delivered | Cost |
| Dec. 27, 2022 | Dr. A | Fever | Paracetamol | 10 | 15 | 15 |
| Dec. 27, 2022 | Dr. A | Fever | Azythromycin | 5 | 5 | 10 |
| Dec. 27, 2022 | Dr. A | Fatigue | Vit B Complex | 30 | 15 | 10 |
| Dec. 27, 2022 | Dr. A | Low back | Vit D | 4 | 4 | 5 |
| | | pain | supplement | | | |
| Dec. 27, 2022 | Dr. A | Low back | Calcium Tablets | 30 | 15 | 20 |
| | | pain | 500 mg | | | |
| Dec. 27, 2022 | Dr. A | Low back | Diclofenac gel | 1 | 1 | 10 |
| | | pain | | | | |
| Dec. 27, 2022 | Dr. B | Diabetes | Glimpride 2 mg | 60 | 30 | 40 |
| Dec. 27, 2022 | Dr. B | Diabetes | Metformin | 60 | 30 | 50 |
| | | | 500 mg | | | |
| Dec. 27, 2022 | Dr. B | Hypertension | Losartan | 60 | 30 | 15 |
| | | | Potassium 50 | | | |
| Dec. 28, 2022 | Dr. A | Diabetes | Voglibose .3 mg | 30 | 30 | 60 |

The document dissector 204 may resolve this data as follows
Date: Dec. 27, 2022, Doctor: “Dr. A”, Diagnosis: Fever, Medicine: Paracetamol, Req:10, Del:15, Cost 15
Date: Dec. 27, 2022, Doctor: “Dr. A”, Diagnosis: Fever, Medicine: Azythromycin, Req:5, Del:5, Cost 10
Date: Dec. 27, 2022, Doctor: “Dr. A”, Diagnosis: Fatigue, Medicine: “Vit B Complex”, Req:30, Del:15, Cost 10
Date: Dec. 27, 2022, Doctor: “Dr. A”. Diagnosis:” Low back pain”. Medicine: “Vit D supplement” Req:4, Del:4, Cost 5
Date: Dec. 27, 2022, Doctor: “Dr. A”, Diagnosis:” Low back pain”, Medicine: “Calcium Tablets 500 mg” Req:30, Del:15. Cost 20
Date: Dec. 27, 2022, Doctor: “Dr. A”, Diagnosis:” Low back pain”, Medicine: “Diclofenac gel” Req:1, Del:1, Cost 10
Date: Dec. 27, 2022, Doctor: “Dr. B”, Diagnosis: Diabetes, Medicine: “Glimpride 2 mg” Req:60, Del:30. Cost 40
Date: Dec. 27, 2022, Doctor: “Dr. B”, Diagnosis: Diabetes, Medicine: “Metformin 500 mg” Req:60, Del:30, Cost 50
Date: Dec. 27, 2022, Doctor: “Dr. B”, Diagnosis: Hypertension, Medicine: “Losartan Potassium 50” Req:60, Del:30, Cost 40
Date: Dec. 27, 2022, Doctor: “Dr. A”, Diagnosis: Diabetes, Medicine: “Voglibose 0.3 mg” Req:30, Del:30, Cost 60

Because this data is of the second type, defined above, the Pre-Processor and the Sentiment Analyzer will be by-passed or will will act as pass through. The dissected records are then passed to the Context-Specific Customization Tool which will identify the context and condition the data, for example, by adding industry, department, service, cost and other tags to each of these records. In this example, Industry: Healthcare, Department: “Pharmacy”, Service: “In patient medicine request”, cost is an adjusted value showing the potential revenue loss, not the cost of medicine as in document dissector.

In this example, the output of context-specific customization tool will be as follows. {Industry: Healthcare, Department: “Pharmacy”, Service: “In patient medicine request”, score:“−0.4”, Date: Dec. 27, 2022, Doctor:” Dr. A″, Diagnosis: Diabetes, Medicine: “Voglibose 0.3 mg” Req:30, Del:30,cost:−40 hash: fd0568e53f09cd0b8050b492b142f35a94db7f4e241a217accc1b2b2a4fdb63b}

The accumulator may track results for multiple Key Performance Indicators (KPI)s that are being monitored. The results from the accumulator for each of the KPIs can be used to determine which KPI is having the greatest impact on the organization's operations or revenue. The Context-Specific Customization Tool will provide a list of KPIs based on the determined context and generate the accumulator result accordingly. In some examples, the requestor may specify which KPIs are to be monitored. Depending on the results from the accumulator for each KPI, the application 200 can predict revenue loss. For example, the KPI with the most negative user sentiment will predict both revenue loss and the cause. Consequently, the KPI needing the most urgent attention and action is identified by the application 200. This produces a clear benefit analysis that gives a clear business case for investment in the department or area associated with the KPI generating negative user sentiment. In this way, the application provides AI-based investment guidance.

For example, KPI: Revenue Loss in Pharmacy {Industry: Healthcare, Department: “Pharmacy”, Service: “In patient medicine request”, score:”−0.99″, Date: All, Doctor All Diagnosis: Diabetes, Medicine: All Req:300K, Del:200K, cost:−400K hash: fd0568e53f09cd0b8050b492b142f35a94db7f4e241a217accc1b2b2a4fdb63b;

### Recommendation: Run Revenue Loss Estimate for all Medicine Maintained in Stock

### KPI: Estimate for Metformin 500 mg (3 Months)

{Industry: Healthcare, Department: “Pharmacy”, Service: “In patient medicine request”, score:”−0.01″, Date: All, Doctor: All Diagnosis: Diabetes, Medicine: “Metformin 500 mg” Req:9000, Del:4500, cost:−20K hash: fd0568e53f09cd0b8050b492b142f35a94db7f4e241a217accc1b2b2a4fdb63b}

Recommendation: Maintain daily balance of Metformin 500 mg over 100. Similarly, the system can monitor KPIs such as revenue loss per doctor, diagnosis etc

In conclusion, the application described herein is a smart AI application that consumes data from various sources. The application will process this input data and will generate business recommendations. The application can be used to provide a business recommendation as a service (BRaaS) solution targeted for each industry verticals, for example, BRaaS for Airlines BRaaS for Banking, BRaaS for HealthCare etc. Thus, the application is a solution providing actionable business steps an organization can take to improve customer satisfaction. It can also provide a perspective on the priority of the recommended actions to be taken.

The application can also, as described herein, be used to identify which KPI has the highest impact on revenue, predict revenue loss for each KPI monitored, provide transparent ways to identify the KPI that needs most urgent action, provides a clear benefit analysis that creates a clear business case for investment in the department or area of business, provide AI based Automated Investment Guidance and provide a KPI improvement consultancy.

What is claimed is:

1. A computer-implemented method, comprising:
with a context-specific customization tool, receiving user data from use of a product or service of a producer by a population of user and determining a context in which the producer provides the product or service;
with the context-specific customization tool, assigning or adjusting a user satisfaction value for elements of the user data based on the determined context; and
with an accumulator, accumulating the values to produce an overall user satisfaction determination that interprets an import of the user data specific to the determined context.

2. The method of claim 1, wherein, when the user data includes user statements, the method further comprises, with a pre-processor, implementing a Natural Language Processing (NLP) tool to disambiguate the user statements by replacing ambiguous terms with specific terms.

3. The method of claim 2, wherein the ambiguous terms comprise pronouns replaced by nouns.

4. The method of claim 2, further comprising, with a sentiment analyzer, assigning a user satisfaction value to each of the user statements.

5. The method of claim 2, further comprising deriving the user data including user statements by taking data from any of social media, user feedback, and user help center records.

6. The method of claim 1, further comprising, with a document dissector, separating out individual user statements from the user data.

7. The method of claim 1, further comprising, with a recommendation generator, applying any of a number of rules to the overall user satisfaction determination to generate a recommendation for responding to the overall user satisfaction determination.

8. The method of claim 1, further comprising training an artificial intelligence to recognize a correct context from the user data.

9. The method of claim 1, wherein the context defines a specific industry in which the product or service is offered.

10. The method of claim 1, wherein the context-specific customization tool and the accumulator are components of an application executed on a server, and the method further comprises:
receiving a request specifying the user data and invoking the application to process the user data with the context-specific customization tool.

11. A server comprising an application to provide a context-specific analysis of a number of statements indicating user sentiment about a product or service of a producer, the server comprising:
a processor;
a memory;
a network interface; and
the application, the application comprising:
a sentiment analyzer to assign a sentiment value to each of the number of statements indicating user sentiment about a product or service of a producer;
a context-specific customization tool to determine a context in which the producer provides the product or service, the context-specific customization tool to adjust or provide the assigned sentiment value for each statement indicating user sentiment based on the determined context; and
an accumulator to accumulate the adjusted sentiment values from the number of statements to produce an overall user sentiment determination that interprets an import of the number of statements corrected for the determined context.

12. The server of claim 11, further comprising a database comprising a library of rules that define adjustments to the assigned sentiment values based on the determined context.

13. The server of claim 11, wherein the application further comprises a pre-processor implementing a Natural Language Processing (NLP) tool to disambiguate the number of statements by replacing ambiguous terms with specific terms.

14. The server of claim 13, wherein the application further comprises a document dissector to separate individual statements from within a document.

15. The server of claim 11, wherein the processor is further programmed to determine from the number of statements a Key Performance Indicator (KPI) that is having a largest impact on revenue.

16. The server of claim 11, wherein the processor is further programmed to predict revenue loss based on a negative user sentiment associated with a Key Performance Indicator (KPI).

17. The server of claim 16, wherein the application further comprises a recommendation generator to apply any of a series of rules to the overall user sentiment determination to generate a recommendation for responding to the overall user sentiment determination, the recommendation based on the KPI with a most negative associated negative user sentiment thereby indicating a greatest need for investment.

18. The server of claim 11, wherein the context-specific customization tool further comprises an artificial intelligence trained to determine the context from the number of statements.

19. A computer program product, the computer program product comprising a computer readable storage medium having program instructions embodied therewith, the program instructions executable by a processor, to cause the processor to implement:
a pre-processor implementing a Natural Language Processing (NLP) tool to disambiguate a number of statements by replacing ambiguous terms with specific terms, the number of statements indicating user sentiment about a product or service of a producer;
a document dissector to separate statements that have been input together into individual statements;
a sentiment analyzer to assign a sentiment value to each of the number of statements;
a context-specific customization tool to determine a context in which the producer provides the product or service, the context-specific customization tool to adjust the assigned sentiment value for each statement indicating user sentiment based on the determined context;
an accumulator to accumulate the adjusted sentiment values from the number of statements to produce an overall user sentiment determination that interprets an import of the number of statements corrected for the determined context; and
a recommendation generator to apply any of a series of rules to the overall user sentiment determination to generate a recommendation for responding to the overall user sentiment determination.

20. The product of claim 19, wherein:
the ambiguous terms comprise pronouns replaced by nouns; and
the context-specific customization tool comprises an artificial intelligence trained to recognize the context from the number of statements.
